(19) United States
(12) Patent Application Publication
(10) Pub. No.: US 2016/0141762 A1
(43) Pub. Date: May 19, 2016

(54) Antenna

(71) Applicant: ZTE CORPORATION, Shenzhen City, Guangdong Province (CN)

(72) Inventors: Wei LI, Shenzhen (CN); Lu ZHANG, Shenzhen (CN)

(21) Appl. No.: 14/895,497

(22) PCT Filed: Aug. 16, 2013
(86) PCT No.: PCT/CN2013/081670

§ 371 Date: Dec. 3, 2015

(30) Foreign Application Priority Data
Jun. 5, 2013 (CN) 201310222144.7

(51) Int. Cl. H01Q 13/10; H01Q 5/20

(52) U.S. Cl. CPC H01Q 13/103; H01Q 5/20

(57) ABSTRACT

Disclosed is an antenna, the antenna includes a metal trace, an antenna feeder, and a power connector set on a printed circuit board (PCB), wherein the metal trance and the antenna feeder are connected at a feed point, the antenna is configured with a reactive element on one surface of the PCB board which is opposite to or the same with the surface where the feed point is located; and when a radio frequency signal of the antenna is at a low frequency, the reactive element is conducted, and when a radio frequency signal of the antenna is at a high frequency, the reactive element is disconnected, or when a radio frequency signal of the antenna is at a low frequency, the reactive element is disconnected, and when a radio frequency signal of the antenna is at a high frequency, a control switch of the reactive element is conducted.

### TECHNICAL FIELD

The present document relates to the field of the antenna technology, and particularly, to an antenna.

BACKGROUND OF THE RELATED ART

With the popularization and development of mobile terminals, an urgent requirement for miniaturization of antennas is presented. At present, multiple-input multiple-output (MIMO) antenna system required by the 4th generation mobile communication 4G also presents new requires for antenna design and evaluation.

On one hand, now the market has harsher requirements for products, the users require the small and delicate identification (ID) design and high quality user experience.

On the other hand, 700 MHz frequency band in long term evolution (LTE) technology at a lower frequency needs a larger antenna size, and the requirements for double antennas of MIMO antenna system and high performance indexes of the radio frequency (high isolation, low correlation coefficient, etc.) will cause the increased product size.

The contradiction between the two hands is prominent in LTE product definition and system scheme stage. Meanwhile, the current LTE data products often cover frequency bands of multiple modes such as global mobile communication system (GSM), Universal Mobile Telecommunications System (UMTS), wireless fidelity (WiFi) system, global position system (GPS), and BT, etc., antennas in the LTE data products have become the primary bottleneck. Conventional materials and conventional antenna design schemes have basically reached the natural limits.

With the rapid developments of the high frequency satellite communication system, radar system and wireless communication system, especially, the global 3G and 4G network construction, the requirement for antennas is increasingly high. On one hand, the antennas are required to be able to work on multiple frequency bands, and have multiple kinds of working modes and good transmission performances; on the other hand, it is required to lessen the weight of the antenna, reduce the volume of the antenna and reduce the costs. Just because of this demand, the concept of the reconfigurable antenna is proposed and is flourishing.

The reconfigurable antenna is a popular antenna technology, the specific idea is to adjust or select different matching circuits or antenna resonance sections for different working frequency bands, which can improve the antenna performance in a limited space.

In recent years, the potential application value for the reconfigurable antennas serving as the transmitting antennas and receiving antennas in the MIMO system is given more and more attention at home and abroad.

In 1983, the concept of reconfigurable antenna was first used by D. Schaubert in his patent titled “Polarization Diverse Microstrip Antenna and Frequency Scanned Arrays”. In 1999, 12 famous universities, research institutes and companies of the United States in the Reconfigurable Aperture Program (RECAP) of the United States Defense Advanced Research Program (DARPA), preliminarily studied and explored the reconfigurable antennas, and achieved some progress.

The antenna which serves as a component used to transmit and receive radio wave plays an important role in the wireless communication system and is an indispensable constituent part of the wireless communication system. Due to the importance of the antenna technology, it will become one of the core technologies in the next generation wireless communication system.

In related art, the problem that the radiation efficiency is low when antenna cover frequency band is wide, but the covering frequency band is narrow when the radiation efficiency is high, exists.

### SUMMARY

The object of the embodiment of the present document is to provide an antenna, which can achieve the wide cover frequency bands and higher radiation efficiency simultaneously.

In order to achieve the above object, the following technical scheme is adopted:
an antenna, comprising a metal trace, an antenna feeder, and a power connector set on a printed circuit board (PCB), wherein the metal trance and the antenna feeder are connected at a feed point;
the antenna is configured with a reactive element on one surface of the PCB board which is opposite to a surface where the feed point is located; and
when a radio frequency signal of the antenna is at a low frequency, it is to conduct the reactive element, and when a radio frequency signal of the antenna is at a high frequency, it is to disconnect the reactive element, or when a radio frequency signal of the antenna is at a low frequency, it is to disconnect the reactive element, and when a radio frequency signal of the antenna is at a high frequency, it is to conduct a control switch of the reactive element.

Alternatively, the antenna is a slot antenna.

Alternatively, the antenna is used in a data card or a terminal;
the power connector is a universal serial bus (USB) connector of the data card, and the USB connector is connected with the reactive element and the control switch.

Alternatively, the reactive element is an inductor or a capacitor.

Alternatively, when the reactive element is an inductor, an inductance of the inductor ranges from 0.8-1.2 nanohenry.

Alternatively, when the reactive element is a capacitor capacitance, a capacitance of the capacitor ranges from 2.0-2.4 pf.

Alternatively, the control switch is a single-pole double-throw switch or a diode.

Alternatively, when the control switch is a diode, a conduction voltage path of the diode is connected to a low frequency circuit or a high frequency circuit of a radio frequency path of the antenna.

Alternatively, the low frequency ranges from 791 to 960 MHz; and
the high frequency ranges from 1710 to 2170 MHz and/or from 2500 to 2690 MHz.

The embodiment of the present document has at least one of the following advantageous effects:

The embodiment of the present document can achieve the wide cover frequency bands and the higher radiation efficiency simultaneously by adding the reactive element and control switch on the original antenna;
the embodiment of the present document can save the antenna space;
the embodiment of the present document has a lower requirement for the control switch, it is only required to have a conduction cut-off feature, thereby providing more conveniences for the digital signal control;

The embodiment of the present document only uses one reactive element to achieve the low frequency and high frequency radiation, which reduces the costs.

### BRIEF DESCRIPTION OF DRAWINGS

FIG. 1 is a trace diagram of one surface of an antenna set on a data card in the related art;

FIG. 2 is a trace diagram of the other surface of the antenna set on the data card in the related art;

FIG. 3 is a back trace diagram of the antenna when the inductor is loaded on the antenna in accordance with an embodiment of the present document;

FIG. 4 is a test result of low frequency return loss when the inductor is loaded on the antenna in accordance with an embodiment of the present document;

FIG. 5 is a test result of high frequency return loss when the inductor is loaded on the antenna in accordance with an embodiment of the present document;

FIG. 6 is a test result of efficiency when the inductor is loaded on the antenna in accordance with an embodiment of the present document;

FIG. 7 is another back trace diagram of the antenna when the capacitor is loaded on the antenna in accordance with an embodiment of the present document;

FIG. 8 is a test result of efficiency when the capacitor is loaded on the antenna in accordance with an embodiment of the present document;

The description of the main component signs is as follows:
1: metal trace, 2: antenna feeder, 3: feed point, 4: power connector, 5: control switch, 6: inductor, 7: capacitor.

### PREFERRED EMBODIMENTS OF THE INVENTION

To make the technical problem to be solved in the embodiment of the present document, the technical schemes and advantages clearer, hereinafter it will be described in detail in conjunction with the accompanying drawings and specific embodiments.

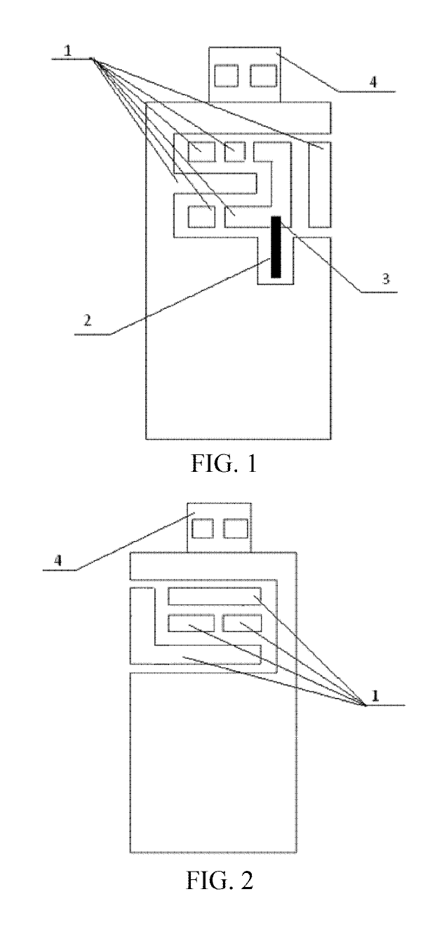

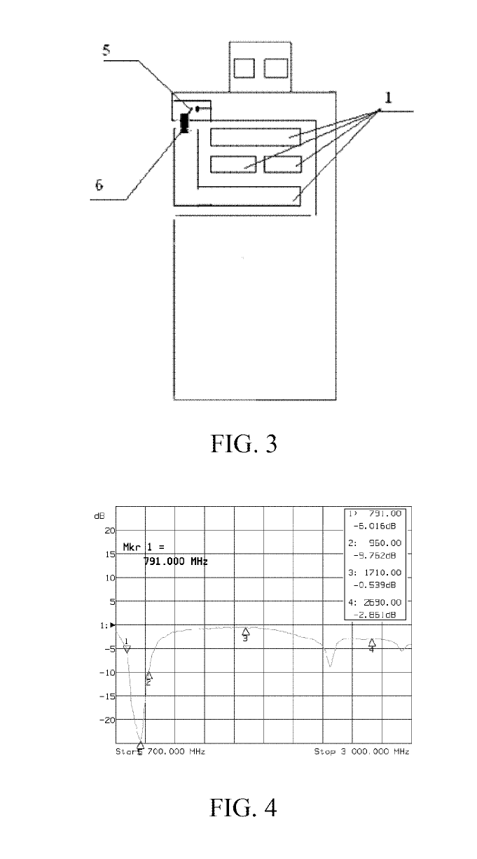

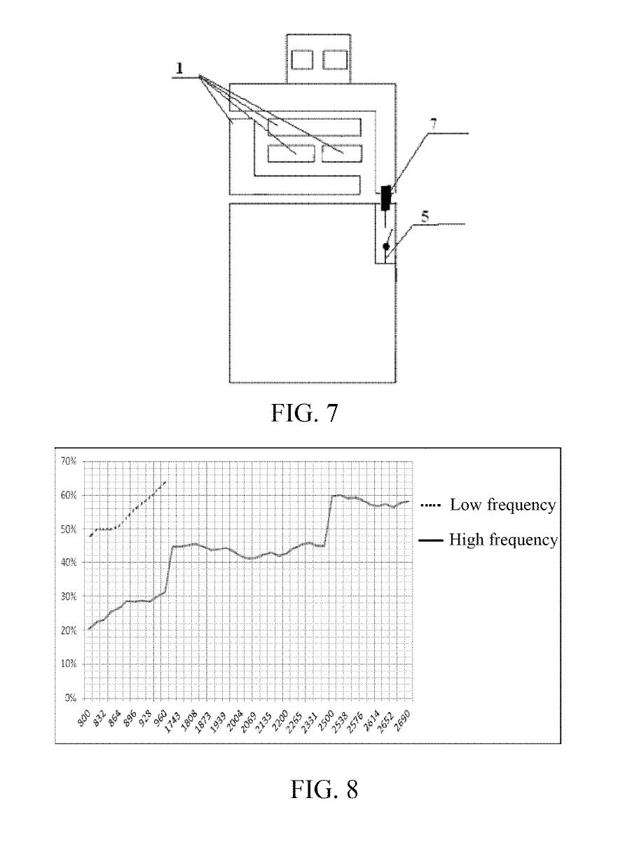

The embodiment of the present document provides an antenna, as shown in FIG. 1, the antenna includes a metal trace 1, an antenna feeder 2 and a power connector 4 set on the printed circuit board (PCB), the metal trace land the antenna feeder 2 are connected at a feed point 3, the antenna is configured with a reactive element on one surface of the PCB board opposite to the surface where the feed point is located as shown in FIG. 3 or FIG. 7.

Wherein, when a radio frequency signal of the antenna is at a low frequency, it is to conduct the reactive element, and when a radio frequency signal of the antenna is at a high frequency, it is to disconnect the reactive element, or when a radio frequency signal of the antenna is at a low frequency, it is to disconnect the reactive element, and when a radio frequency signal of the antenna is at a high frequency, it is to conduct a control switch 5 of the reactive element.

Of course, the above reactive element and the control switch 5 further can be set on one surface of the PCB board which is the same with the surface where the feed point is located.

In the embodiment, the reactive element and the control switch 5 used to control the reactive element to be conducted or connected are set on one surface of the PCB opposite to the surface where the feed point is located. When the radio frequency signal of the antenna is at a low frequency, the control switch 5 conducts the reactive element to achieve the radiation effect at the low frequency, the experimental results have proved that there is a deep return loss in frequency bands of 791-960MHz;

While, when the radio frequency signal of the antenna is at a high frequency, the control switch 5 disconnects the reactive element to achieve the radiation effect of at the high frequency, the experimental results have proved that there are deep return losses in frequency bands of 791-960 MHz and frequency bands of 2500-2690 MHz respectively.

The above three frequency bands have almost covered the communication frequency band often used, and achieve the deeper resonance and higher radiation efficiency, without adding a new trace form of the antenna and matching materials.

From the above process, it can be seen that, the embodiment of the present document achieves the radiation of the antenna at the low frequency band and high frequency band, i.e., achieves wide cover frequency bands of the antenna by adding the reactive element and control switch 5. At same time, after testing the efficiency of the antenna, it can be drawn that, the efficiency of the antenna at the corresponding frequency band has reached 50%, compared with the previous efficiency standard of 40%, which has improved a lot.

Wherein, alternatively, the antenna is a slot antenna, and is used in the data card, and here, the power connector 4 is a universal serial bus (USB) connector of the data card, as shown in FIG. 3 or FIG. 7, the USB connector is connected with the reactive element and the control switch 5.

The above-mentioned antenna can be further used in a terminal, for example, a cellphone, etc.

The above-mentioned reactive element can be an inductor 6 or a capacitor 7.

In addition, in the embodiment of the present document, there is a lower requirement for the control switch 5, it is only required to have a conduction cut-off feature, alternatively, the control switch can be a single-pole double-throw switch or a diode.

If a diode is adopted as the control switch 5, a conduction voltage path of the diode is connected to a low frequency circuit of a radio frequency path of the antenna.

When the data card is integrated in the terminal, the low frequency circuit of the radio frequency path can be the GSM850/900, WCDMA850/900, DMA850, LTE band 8/20, etc., and the specific frequency band can be determined according to the frequency band supported by the data card.

When the terminal works on the above low frequency bands, the signal voltage must be generated on the low frequency circuit of the radio frequency, the voltage is mainly used to guarantee the low frequency feature of the terminal, and an additional small part of the voltage is used to provide the conduction voltage for the diode switch to guarantee the diode to be conducted, so that the reactive element on the antenna trace is in a connected state, which achieves the object of the antenna working on the low frequency band; similarly, when the terminal works on the high frequency bands, the signal voltage is generated on the high frequency circuit of the radio frequency, and the signal voltage is not generated on the low frequency circuit of the radio frequency, and the conduction voltage used to conduct the diode is not generated, so the diode is in a non-conduction state, and the reactive element on the antenna trace is in a disconnected state, thereby the antenna works on the high frequency.

In view of the different forms of switches, other types of antenna forms can be further adopted, such as a mechanical Micro electro mechanical system MEMS switch, etc., which can only achieve the effect of the conduction and disconnection.

The embodiment of the present document will be described in details below by taking the slot antenna set on the data card as an example.

As shown in FIG. 1 and FIG. 2, the trace diagrams of the slot antenna on both surfaces of the data card in related art are shown. Wherein, the slot antenna includes a metal trace 1, an antenna feeder 2 and a power connector 4 set on the printed circuit board (PCB), the metal trace 1 and the antenna feeder 2 are connected at a feed point 3, the power connector 4 is a universal serial bus (USB) connector of the data card.

Compared with the related art, the alternative embodiment one of the present document provides the slot antenna set on the data card, one of the two surfaces of the antenna is shown in FIG. 1, including a metal trace 1, an antenna feeder 2 and a power connector 4 set on the printed circuit board (PCB), wherein the metal trace 1 and the antenna feeder 2 are connected at a feed point 3, while one surface on the PCB board which is opposite to the surface where the feed point 3 is located is shown in FIG. 3, on that surface, the antenna is configured with a reactive element, here the reactive element is the inductor 6; and

Alternatively, when a radio frequency signal of the antenna is at a low frequency, it is to conduct the reactive element, and when a radio frequency signal of the antenna is at a high frequency, it is to disconnect the control switch 5 of the reactive element.

When the inductance 6 is adopted as the reactive element, when the inductance of the inductor 6 ranges from 0.8 to 1.2 nanohenry, the wide cover frequency band of the antenna can be achieved and the radiation efficiency of the antenna can also be improved simultaneously.

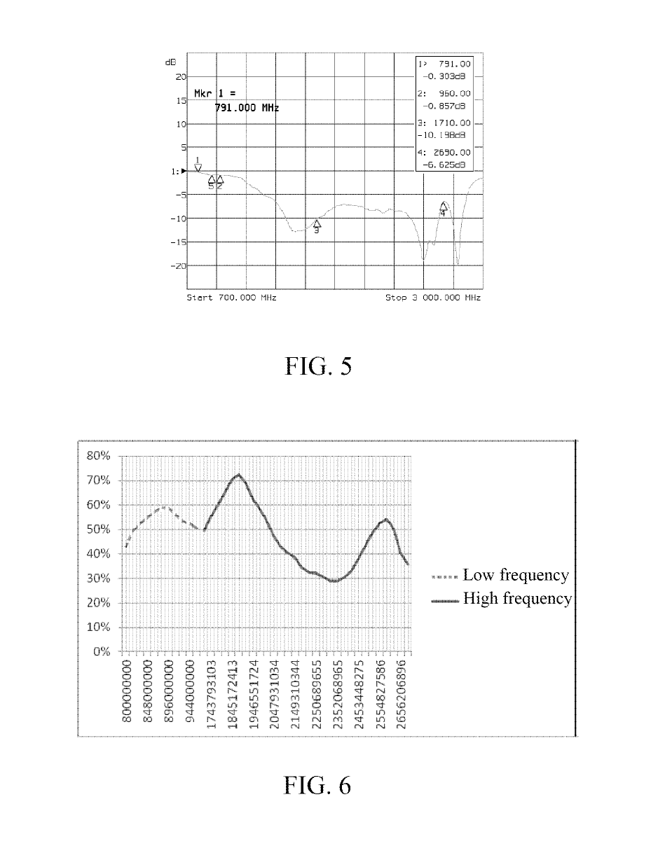

Alternatively, the inductance of inductor 6 is 1 nanohenry, there is a resonance with the deepest being −25 dB in the frequency band of 791-960 MHz, while there is almost no resonance in the frequency band of 1710-2690 MHz, that is, at that moment, the antenna shows the radiation performance of the frequency band of the low frequency 791-960 MHz; and when this inductor of 1 nanohenry is removed, a resonance with the deepest being −20 dB occurs in the frequency band of 1710-2170 MHz, while no resonance occurs in the frequency band of 791-960 MHz, and at that moment, the antenna shows the radiation performance of the frequency band of the high frequency 1710-2690 MHz. At this point, the test results of the corresponding antenna return losses at the low frequency and high frequency are shown in FIG. 4 and FIG. 5 respectively. It can be see that, the frequency bands in the embodiment of the present document have covered all the common frequency bands on which the data card works, including the GSM850/900/1800/1900, WCDMA850/900/1900/2100, CDMA800/1900, LTE band1/3/7/8/20,etc., moreover, the infrequently used FDD frequency bands such as the LTE bands 2/4/5/6/9/10/11/18/19 and the TDD frequency bands such as the LTE bands 33/34/35/36/37/38/39/40/41 are included, even the 2.4G WiFi frequency band is further included. Thereby, the antenna provided by the embodiment of the present document absolutely can be used to achieve the functions of the above frequency bands, which has great significance to reduce the system complexity and the production cost.

Moreover, when the inductance of the inductor 6 is 1 nanohenry, the radiation efficiency test for the antenna is shown in FIG. 6, it can be seen that at that moment, the radiation efficiencies of the antenna at both low frequency and high frequency are more than 50%, which has a greater promoted function for debugging the indexes of the over-the-air (OTA) technology such as total radiated power (TRP), total isotropic sensitivity (TIS), etc working under an active state.

From the above-mentioned process, it can be seen that, the alternative embodiment one of the present document achieves the wide cover frequency bands and higher radiation efficiency of the antenna simultaneously.

Of course, the inductance values of the inductor can change with the specific trace forms, etc., of the antenna, which is not limited to the range from 0.8 to 1.2 nanohenry mentioned in the embodiment of the present document.

The alternative embodiment two of the present document provides a slot antenna set on the data card, one of the two surfaces of the antenna is shown in FIG. 1, including a metal trace 1, an antenna feeder 2 and a power connector 4 set on the printed circuit board (PCB), wherein the metal trace 1 and the antenna feeder 2 are connected at a feed point 3, while a reactive element is set on one surface on the PCB board which is opposite to the surface where the feed point 3 is located as shown in FIG. 7, here the reactive element is the capacitor 7; and

When a radio frequency signal of the antenna is at a low frequency, it is to conduct the reactive element, and when a radio frequency signal of the antenna is at a high frequency, it is to disconnect the control switch 5 of the reactive element.

When the capacitor 7 is adopted as the reactive element, when the capacitance of the capacitor 7 ranges from 2.0 to 2.4 pf, the wide cover frequency bands of the antenna can be achieved and the radiation efficiency of the antenna can also be improved simultaneously.

Alternatively, the capacitance of the capacitor 7 is 2.2 pf, at that moment, the corresponding test results of the antenna return losses at the low frequency and high frequency are almost the same with results when adopting the inductor of 1 nanohenry; and at that moment, the radiation efficiency test for the antenna is shown in FIG. 8, it can be seen that, the radiation efficiencies of the antenna at the low frequency and high frequency are both more than 50% as well.

In the embodiment of the present document, the locations of the reactive element and control switch are not limited to the locations in FIG. 3 and FIG. 7, the reactive element can set on any location on one surface of the PCB, which is opposite to the surface where the feed point 3 is located, which can connect with the power connector and be powered by the power connector.

In addition, the antenna described in the embodiment of the present document is not limited to the slot antenna, other active antennas with power interfaces in which the reactive element can be conducted through the control switch when the radio frequency signal of the antenna is at a low frequency and the reactive element can be disconnected when the radio frequency signal of the antenna is at a high frequency, should be considered as in the protection scope of the present document.

Compared with most of the current methods for adopting a switch to switch to different traces to achieve the purpose of changing the radiation frequency band, the method provided by the embodiment of the present document does not need more trace, which saves the antenna space, and undoubtedly has deeper significance for the terminals with the smaller space such as a data card; and has a lower requirement for the switch, the switch is only required to have a conduction cut-off feature, so as to provide more conveniences for the digital signal control, while for the traditional switch for switching different traces, the switch is not only required to have multiple connected states, but also it is not easily achieved in the terminals with the smaller space such as the data card, since the embodiment of the invention only uses one reactive element to achieve the radiation at the low frequency and high frequency, compared with the scheme that needs at least two sets of matching to switch to the low frequency or high frequency, the costs are undoubtedly reduced.

The various advantages of the electric tilt antenna can bring many benefits for all aspects of the wireless terminal industry. For the operators, they can increase the network bandwidth at the low infrastructure costs, and have more chances to improve the customer satisfaction through the higher quality services, and thereby achieving the purpose of reducing the customer loss. For the wireless terminal manufacturers, they can achieve multi-decibel performance gain, reduce the costs of bill of materials (BOM), complexity, and further can make a more compact and thin appearance, reduce the inventory of stock keeping units (SKU), and let the products to be on sale quickly. For the users, the probability of missed call chances is reduced, the battery life can be extended more than 35%, and the users can buy terminals with more functions at the low price, and enjoy the conveniences brought by the wireless at anytime and anywhere. The tunable antenna with these advantages is bound to become the mainstay of the LTE.

The above description is the preferable embodiments of the present document. It should be pointed out, for those skilled in the art, a plurality of modifications and retouches also can be made without departing from the principles of the present document, and all the modifications and retouches should be embodied in the protection scope of the present document.

### INDUSTRIAL APPLICABILITY

The embodiment of the present document achieves the wide covering frequency bands and higher radiation efficiency simultaneously by adding the reactive element and control switch on the original antenna; and reduces the antenna space; has a lower requirement for the control switch, it only requires to have the conduction cut-off feature, so as to provide more conveniences for the digital signal control; and only uses one reactive element to achieve the radiation at low frequency and high frequency, which reduces the costs. Therefore, the present document has very strong industrial applicability.

What is claimed is:

1. An antenna, comprising a metal trace, an antenna feeder, and a power connector set on a printed circuit board (PCB), wherein the metal trance and the antenna feeder are connected at a feed point, and wherein:
the antenna is configured with a reactive element on one surface of the PCB board which is opposite to or same with a surface where the feed point is located; and
when a radio frequency signal of the antenna is at a low frequency, it is to conduct the reactive element, and when a radio frequency signal of the antenna is at a high frequency, it is to disconnect the reactive element, or when a radio frequency signal of the antenna is at a low frequency, it is to disconnect the reactive element, and when a radio frequency signal of the antenna is at a high frequency, it is to conduct a control switch of the reactive element.

2. The antenna according to claim 1, wherein, the antenna is a slot antenna.

3. The antenna of claim 2, wherein:
the antenna is used in a data card or a terminal;
the power connector is a universal serial bus (USB) connector of the data card, and the USB connector is connected with the reactive element and the control switch.

4. The antenna of claim 2, wherein, the reactive element is an inductor or a capacitor.

5. The antenna of claim 4, wherein, when the reactive element is an inductor, an inductance of the inductor ranges from 0.8-1.2 nanohenry.

6. The antenna of claim 4, wherein, when the reactive element is a capacitor, a capacitance of the capacitor ranges from 2.0-2.4 pf.

7. The antenna of claim 2, wherein, the control switch is a single-pole double-throw switch or a diode.

8. The antenna of claim 7, wherein, when the control switch is a diode, a conduction voltage path of the diode is connected to a low frequency circuit or a high frequency circuit of a radio frequency path of the antenna.

9. The antenna of any one of claims 24, wherein:
the low frequency ranges from 791 to 960 MHz;
the high frequency ranges from 1710 to 2170 MHz and/or from 2500 to 2690 MHz.

10. The antenna of claim 3, wherein:
the low frequency ranges from 791 to 960 MHz;
the high frequency ranges from 1710 to 2170 MHz and/or from 2500 to 2690 MHz.

11. The antenna of claim 4, wherein:
the low frequency ranges from 791 to 960 MHz;
the high frequency ranges from 1710 to 2170 MHz and/or from 2500 to 2690 MHz.

12. The antenna of claim 5, wherein:
the low frequency ranges from 791 to 960 MHz;
the high frequency ranges from 1710 to 2170 MHz and/or from 2500 to 2690 MHz.

13. The antenna of claim 6, wherein:
the low frequency ranges from 791 to 960 MHz;
the high frequency ranges from 1710 to 2170 MHz and/or from 2500 to 2690 MHz.

14. The antenna of claim 7, wherein:
the low frequency ranges from 791 to 960 MHz;
the high frequency ranges from 1710 to 2170 MHz and/or from 2500 to 2690 MHz.

15. The antenna of claim 8, wherein:
the low frequency ranges from 791 to 960 MHz;
the high frequency ranges from 1710 to 2170 MHz and/or from 2500 to 2690 MHz.
